(19) United States
(12) Patent Application Publication
(10) Pub. No.: US 2013/0311977 A1
(43) Pub. Date: Nov. 21, 2013

(54) ARRANGEMENT AND METHOD FOR MODEL-BASED TESTING

(71) Applicants: Mikko Nieminen, Vtt (FI); Tomi Raty, Oulu (FI)

(72) Inventors: Mikko Nieminen, Vtt (FI); Tomi Raty, Oulu (FI)

(73) Assignee: Teknologian turtkimuskeskus VTT, Vtt (FI)

(21) Appl. No.: 13/982,043

(22) PCT Filed: Feb. 2, 2012
(86) PCT No.: PCT/FI2012/050097

§ 371 Date: Jul. 26, 2013

(30) Foreign Application Priority Data
Feb. 2, 2011 (FI) 20115104

(51) Int. Cl. G06F 11/36

(52) U.S. Cl. CPC G06F 11/3688
USPC 717/135

(57) ABSTRACT

An electronic arrangement for analyzing a model-based testing scenario relating to a system under test (SUT), includes a model handler entity for obtaining and managing model data indicative of a model intended to exhibit the behavior of the SUT, a test plan handler entity for obtaining and managing test plan data indicative of a number of test cases relating to the model and expected outcome thereof, a test execution log handler entity for obtaining and managing test execution log data indicative of the execution of the test cases by the test executor and/or SUT, a communications log handler entity for obtaining and managing communications log data indicative of message traffic between the test executor entity and SUT, and an analyzer entity for detecting a number of failures and their causes in the model-based testing scenario on the basis of model, test plan, test execution log and communications log data.

### FIELD OF THE INVENTION

Generally the present invention pertains to testing such as software testing. In particular, however not exclusively, various embodiments of the present invention are related to model-based testing and remote testing.

### BACKGROUND

Software testing often refers to a process of executing a program or application in order to find software errors, i.e. bugs, which reside in the product. In more general terms, software testing may be performed to validate the software against the design requirements thereof and to find the associated flaws and peculiarities. Both functional and non-functional design requirements may be evaluated. Yet, the tests may be executed at unit, integration, system, and system integration levels, for instance. Testing may be seen as a part of the quality assurance of the tested entity.

Traditionally, testing of software and related products, such as network elements and terminals in the context of communication systems, has been a tedious process providing somewhat dubious results. Main portion of the overall testing process has been conducted manually incorporating test planning, test execution, and the analysis of the test results.

Model-based testing has been introduced to facilitate the testing of modern software that may be both huge in size and complex by nature. In model-based testing, the SUT (system under test) is modeled with a model that describes at least part of the system's intended behavior. The SUT may, despite its name, contain only a single entity such as an apparatus to be tested. Alternatively, a plurality of elements may constitute the SUT. The model is used to generate a number of test cases that have to be ultimately provided in an executable form to enable authentic communication with the SUT. Both online and offline testing may be applied in connection with model-based testing. In the context of model-based testing, at least some phases of the overall testing process may be automated. For example, the model of the SUT and the related test requirements may be applied as input for a testing tool capable of deriving the test cases on the basis thereof somewhat automatically. However, in practice high level automatization has turned out to be rather difficult in conjunction with the more complex SUTs. Nevertheless, the execution of the derived tests against the SUT is normally followed by the analysis of the related test reports, which advantageously reveals the status of the tested entity in relation to the tested features thereof.

According to one viewpoint, software testing may be further coarsely divided into white box testing and black box testing. In white box approach the internal data structures and algorithms including the associated code of the software subjected to testing may be applied whereas in black box testing the SUT is seen as a black box the internals of which are not particularly taken into account during testing. An intermediate solution implies grey box testing wherein internal data structures and algorithms of the SUT are utilized for designing the test cases, but the actual tests are still executed on a black-box level. Model-based testing may be realized as black box testing or as a hybrid of several testing methods.

When the applied testing procedure indicates a problem in the implementation of the SUT, it may be desirable to identify the root cause of the problem and stick to that in the light of corrective actions instead of addressing mere individual symptoms that are different instances of the same underlying root cause. In view of the foregoing, RCA (Root Cause Analysis) refers to problem solving where the fundamental reason, i.e. the root cause, of an error, or generally of a problem or incident, is to be identified. Techniques that are generally applicable in RCA include, but are not limited to, events and causal factor charting, change analysis, Barrier analysis, tree diagrams, why-why chart (“Five-whys” sequence), pareto analysis, storytelling method, fault tree analysis, failure modes and effect analysis, and realitycharting.

In some contemporary solutions, the initial part of the model-based testing process has been more or less automated, which refers to the creation of test cases on the basis of the available model of the SUT as alluded hereinbefore. However, the actual analysis of the test results is still conducted manually on the basis of a generated test log. In practice, the manual analysis may require wading through a myriad of log lines and deducing the higher level relationships between different events to trace down the root causes completely as a mental exercise. With complex SUTs that may utilize e.g. object oriented programming code and involve multiple parallel threads, digging up the core cause of a failed test may just be in many occasions impossible from the standpoint of a human tester. Such a root cause is not unambiguously traceable due to the excessive amount of information to be considered. Numerous working hours and considerable other resources may be required for successfully finishing the task, if possible at all.

For example, in connection with 2G and 3G cellular networks system testing, e.g. MSS (Mobile Switching Centre Server) testing or testing of other components, problematic events such as error situations do not often materialize as unambiguous error messages. Instead, a component may simply stop working, which is one indication of the underlying error situation. The manual analysis of the available log file may turn out extremely intricate as the MSS and many other components transmit and receive data in several threads certainly depending on the particular implementation in question, which renders the analysis task both tricky and time-consuming.

Further, different infrastructural surveillance systems are prone to malfunctions and misuse, which cause the systems to operate defectively or may render the whole system out of order. The infrastructural surveillance systems often reside in remote locations, which cause the maintenance to be expensive and slow. It would be essential to be able to execute fault diagnosis in advance before potential faults cascade and threat the overall performance of these systems.

### SUMMARY OF THE INVENTION

The objective is to alleviate one or more problems described hereinabove not yet addressed by the known testing arrangements, and to provide a feasible solution for at least partly automated analysis of the test results conducted in connection with model-based testing to facilitate failure detection and cause tracking such as root cause tracking.

The objective is achieved by embodiments of an arrangement and a method in accordance with the present invention. The invention enables, in addition to failure detection and cause tracking of the SUT, failure detection and related analysis of various other aspects and entities of the overall testing scenario, such as the applied model, test plan, associated test cases and test execution. Different embodiments of the present invention may be additionally or alternatively be configured to operate as a remote testing and analyzing (RTA) tool for remote analogue and digital infrastructural surveillance systems, for instance. These systems are or incorporate e.g. alarm devices, access control devices, closed-circuit television systems and alarm central units.

Accordingly, in one aspect of the present invention an electronic arrangement, e.g. one or more electronic devices, for analyzing a model-based testing scenario relating to a system under test (SUT) comprises
a model handler entity configured to obtain and manage model data indicative of a model intended to at least partially exhibit the behavior of the SUT,
a test plan handler entity configured to obtain and manage test plan data indicative of a number of test cases relating to the model and the expected outcome thereof,
a test execution log handler entity configured to obtain and manage test execution log data indicative of the execution of the test cases by the test executor and/or the SUT,
a communications log handler entity configured to obtain and manage communications log data indicative of message traffic between the test executor entity and the SUT, and
an analyzer entity configured to detect a number of failures and their causes, preferably root causes, in the model-based testing scenario on the basis of the model data, test plan data, test execution log data and communications log data, wherein the analyzer is configured to apply a rule-based logic to determine the failures to be detected.

In one embodiment, the analyzer entity is configured to compare test plan data, test execution log data, and/or communications log data with model data to detect errors in the model.

In another embodiment, the analyzer entity is configured to compare model data, test execution log data, and/or communications log data with test plan data to detect errors in the test plan data such as error(s) in one or more test case definitions.

In a further embodiment, the analyzer entity is configured to compare model data and/or test plan data with test execution log data and/or communications log data to detect errors in the related test run(s).

Yet in a further embodiment, the model of the SUT may include a state machine model such as a UML (Unified Modeling Language) state machine model. The state machine model may particularly include a state machine model in XMI (XML Metadata Interchange) format. The model handler entity may be configured to parse the model for use in the analysis. For example, a network element (SUT) such as an MSS of e.g. 2G or 3G cellular network may be modeled. The model may indicate the behavior of the entity to be modeled. The model handler entity may be configured to obtain, such as retrieve or receive, model data and manage it, such as parse, process and/or store it, for future use by the analyzer entity.

Still in a further embodiment, the test plan may include a number of HTML (Hypertext Markup Language) files. The test plan and the related files may include details regarding a number of test cases with the expected message sequences, message field content, and/or test results. The test plan handler entity may be configured to obtain, such as retrieve or receive, test plan data and parse it for future use by the analyzer entity.

In a further embodiment, the test execution log, which may substantially be a textual log, may indicate the details relating to test execution against the SUT from the standpoint of the test executor (tester) entity. Optionally the execution log of the SUT may be exploited. An executed test script may be identified, the particular location of execution within the script may be identified, and/or the problems such as errors and/or warnings, e.g. a script parsing warning, relating to the functioning of the entity may be identified. The test execution log handler entity may be configured to obtain such as retrieve or receive the log and manage it such as parse and store it according to predetermined rules for later use by the analyzer entity.

In a further embodiment, the communications log, which may substantially be a textual log, indicates traffic such as messages transferred between the test executor and the SUT. The log may be PCAP-compliant (packet capture).

In a further embodiment, the analyzer entity may be configured to traverse through data in the model data, test plan data, test execution log data, and/or communications log data according to the rule-based logic in order to trace down the failures.

In a further embodiment, the rule-based logic may be configured to apply logical rules. The rules may include or be based on Boolean logic incorporating Boolean operators, for instance. Each rule may include a number of conditions. Two or more conditions may be combined with an operator to form a logical sentence the fulfillment of which may trigger executing at least one action such as a reporting action associated with the rule. The rules may at least partially be user-determined and/or machine-determined. Accordingly, new rules may be added and existing ones deleted or modified. The rules and related software algorithms corresponding to the rule conditions may define a number of predetermined failures to be detected by the analyzer. The rules may be modeled via XML (eXtensible Markup Language), for example.

In a further embodiment, a database entity of issues encountered, e.g. failures detected, during the analysis rounds may be substantially permanently maintained to facilitate detecting recurring failures and/or (other) complex patterns in the longer run.

In a further embodiment, the arrangement further comprises a report generation entity. The analysis results may be provided in a number of related reports, which may be textual format files such as XML files, for instance. An XSL (Extensible Stylesheet Language) style sheet may be applied for producing a human readable view to the data. A report may include at least one element selected from the group consisting of: an indication of a failure detected relative to the testing process, an indication of the deducted cause of the failure, an indication of the seriousness of the failure (e.g. security level), an indication of the failure source (causer), overall number of failures detected, an indication of the SUT details such as a version or build number, and an indication of testing environment details such as the applied model, test plan and/or executed test case, test execution software, test execution hardware, test execution logging entity, analyzer entity (e.g. version id), analysis rules (e.g. version id), test execution mode (e.g. offline/online) and/or communications logging entity. A report may be automatically generated upon analysis.

In a further embodiment, the SUT includes a network element such as the aforesaid MMS. Alternatively, the SUT may include a terminal device. In a further option, the SUT may include a plurality of at least functionally interconnected entities such as devices. The SUT may thus refer to a single apparatus or a plurality of them commonly denoted as a system.

In a further embodiment, one or more of the arrangement's entities may be integrated with another entity or provided as a separate, optionally stand-alone, component. For instance, the analyzer may be realized as a separate entity that optionally interfaces with other entities through the model and log files. Generally, in the embodiments of the arrangement, any aforesaid entity may be at least logically considered as a separate entity. Each entity may also be realized as a distinct physical entity communicating with a number of other physical entities such as devices, which may then together form the testing and/or analysis system. In some embodiments, the core analyzer subsystem may be thus implemented separately from the data retrieval, parsing, and/or reporting components, for example.

In another aspect of the present invention, a method for analyzing a model-based testing scenario relating to a system under test (SUT), comprises
obtaining model data indicative of a model intended to at least partially exhibit the behavior of the SUT,
obtaining test plan data indicative of a number of test cases relating to the model and the expected outcome thereof,
obtaining test execution log data indicative of the execution of the test cases by the test executor and/or the SUT,
obtaining communications log data indicative of traffic between the test executor entity and the SUT, and
conducting analysis incorporating detecting a number of failures and their causes in the model-based testing scenario on the basis of the model data, test plan data, test execution log data and communications log data, wherein a rule-based logic is applied to determine a number of characteristics of the failures to be detected.

The previously presented considerations concerning the various embodiments of the arrangement may be flexibly applied to the embodiments of the method mutatis mutandis and vice versa, as being appreciated by a skilled person.

To meet the objective associated with surveillance systems, i.e. to detect potential abnormalities and malfunction in the remote surveillance system under test, related data flow may be monitored and analyzed. In some of these embodiments the arrangement may additionally or alternatively comprise entities such as
an alarm configuration data handler entity to obtain, parse and manage surveillance system configuration data received from the surveillance system,
an alarm event data handler entity to obtain, parse and manage surveillance system alarm event data received from the surveillance system,
a rule generator entity to automatically create rules according to surveillance system alarm configuration data and alarm event data, which are used to teach the surveillance system behavior to the RTA,
a rule handler entity to store and manage rules that describe certain unique events or sequences of events in the surveillance system, and
an analyzer entity configured to automatically analyze information obtained from the remote surveillance system under testing with rule-based analysis methods according to the rules generated by the rule generator entity

In one related embodiment, the analyzer entity may be configured to compare rules generated from the alarm configuration data to alarm event data received from the surveillance system under testing to detect potential faults and abnormalities in the surveillance system.

In another related embodiment, the analyzer entity may be configured to compare rules generated from the historical alarm event data to recent alarm event data received from the surveillance system under testing to detect potential faults and abnormalities in the surveillance system.

The utility of the present invention arises from a plurality of issues depending on each particular embodiment. The rule and database based analysis framework facilitates discovery of complex failures caused by multiple atomic occurrences. Flaws may be detected in the functioning of the SUT, in the execution of test runs, and in the model itself.

For example, the model, test plan and associated test cases (e.g. sequence charts), logs of the entity executing the test (i.e. executor), and logs indicative of message traffic between the executor and the SUT may be applied in the analysis. Among other options, actual response of the SUT may be compared with the expected response associated with the test cases to determine whether the SUT works as modeled. Likewise, actual response of the SUT may be compared with functionality in the model of the SUT for the purpose. On the other hand, actual functioning of the test executor may be compared with the expected functioning in the test cases to determine whether the executor works as defined in the test cases. Yet, the created test cases may be compared with the expected function in the SUT model to determine whether the test cases have been properly constructed.

Maintaining a local database or other memory entity regarding the failures detected enables the detection of repeating failures. Test case data may be analyzed against the model of the SUT to automatically track potential failure causes from each portion of the SUT and the testing process. As a result, determining the corresponding causes and e.g. the actual root causes is considerably facilitated.

Moreover, the analysis may be generally performed faster and more reliably with automated decision-making; meanwhile the amount of necessary manual work is reduced. The rule-based analysis enables changing the analysis scope flexibly. For example, new analysis code may be conveniently added to trace down new failures when necessary. Separating e.g. the analyzer from data retrieval and parsing components reduces the burden in the integration of new or changing tools in the testing environment. Further, new components may be added to enable different actions than mere analysis reporting, for instance, to be executed upon fault discovery. The existing components such as testing components may remain unchanged when taking the analyzer or other new component into use as complete integration of all the components is unnecessary. Instead, the analyzer may apply a plurality of different interfaces to input and output the data as desired. The testing software may be integrated with the analysis software, but there's no absolute reason to do so.

To address the aforementioned problems and potential faults manifesting in infrastructural surveillance systems, the RTA embodiments of the present invention may be made capable of monitoring and analyzing these systems, which comprises monitoring and storing the data flow in the remote surveillance system under test (RSSUT). Such data flow comprises events, which are occurrences in the RSSUT. E.g. in an alarm system an event could be a movement detected by an alarm sensor. The analyzing feature comprises rule-based analysis, which means that the RTA analyzes events and event sequences against explicitly defined rules. These rules depict event sequences that can be used to define occurrences that are e.g. explicitly abnormal in the infrastructural surveillance systems under analysis. The RTA may also analyze the RSSUT events by using sample based analysis, which utilizes learning algorithms to learn the RSSUT behaviour.

The expression “a number of” refers herein to any positive integer starting from one (1), e.g. to one, two, or three.

The expression “a plurality of” refers herein to any positive integer starting from two (2), e.g. to two, three, or four.

The term “failure” may broadly refer herein to an error, a fault, a mismatch, erroneous data, omitted necessary data, omitted necessary message, omitted execution of a necessary action such as a command or a procedure, redundant or unfounded data, redundant or unfounded message, redundant or unfounded execution of an action such as command or procedure detected in the testing process, unidentified data, unidentified message, and unidentified action. The failure may be due to e.g. wrong, excessive, or omitted activity by at least one entity having a role in the testing scenario such as obviously the SUT.

Different embodiments of the present invention are disclosed in the dependent claims.

### BRIEF DESCRIPTION OF THE RELATED DRAWINGS

Next the invention is described in more detail with reference to the appended drawings in which

FIG. 1a is a block diagram of an embodiment of the proposed arrangement.

FIG. 1b illustrates a part of an embodiment of an analysis report.

FIG. 1c illustrates a use case of an embodiment of the proposed arrangement in the context of communications systems and related testing.

FIG. 2 is a block diagram of an embodiment of the proposed arrangement with emphasis on applicable hardware.

FIG. 3 is a flow chart disclosing an embodiment of a method in accordance with the present invention.

FIG. 4 is a flow chart disclosing an embodiment of the analysis internals of a method in accordance with the present invention.

FIG. 5a is a block diagram of an embodiment of the arrangement configured for RTA applications.

FIG. 5b illustrates a part of an analysis report produced by the RTA embodiment.

FIG. 6 is a flow chart disclosing an embodiment of the RTA solution in accordance with the present invention.

FIG. 7 is a flow chart disclosing an embodiment of the analysis internals of the RTA solution in accordance with the present invention.

### DETAILED DESCRIPTION OF THE EMBODIMENTS

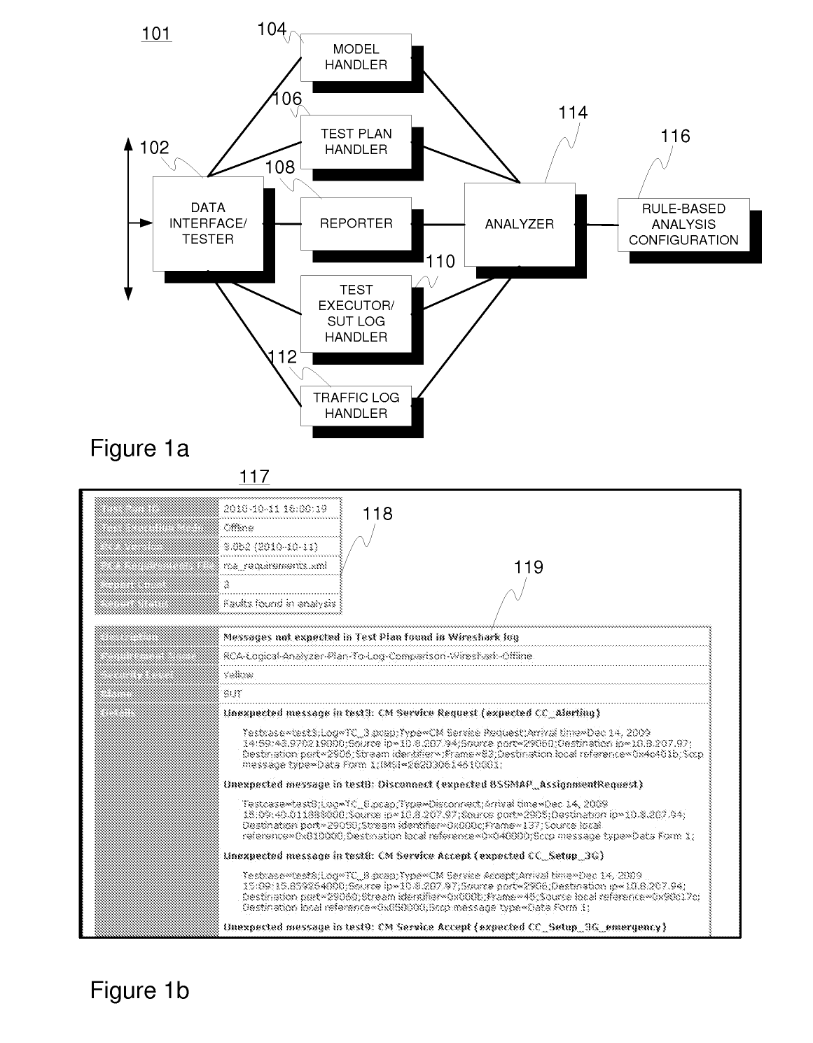

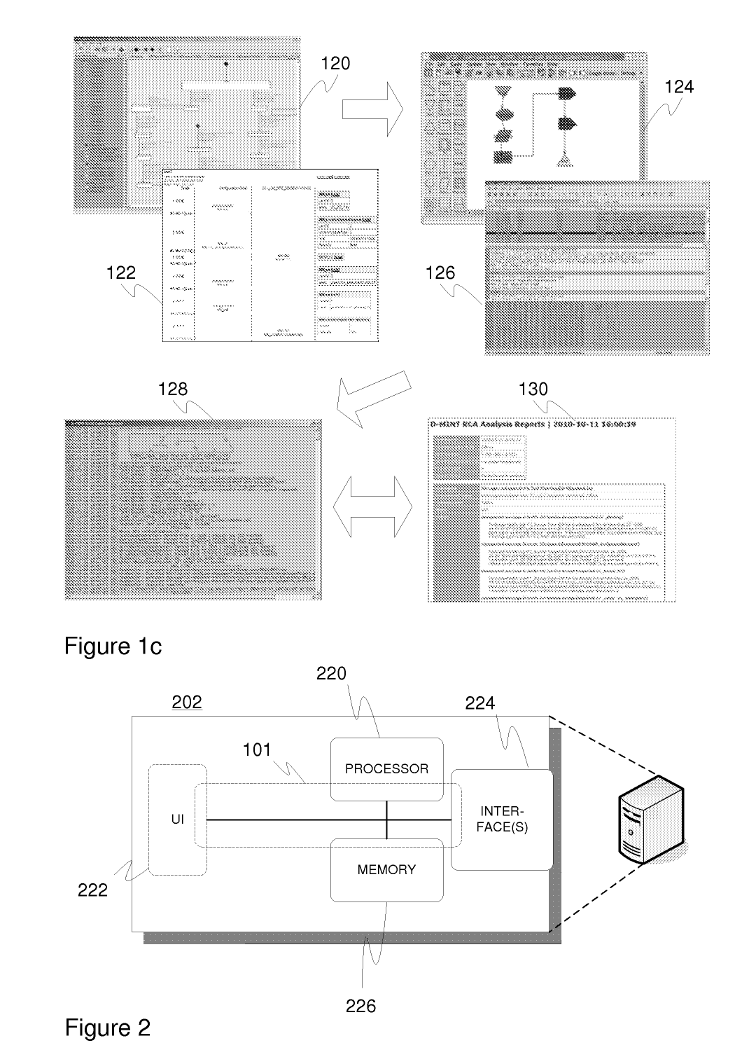

FIG. 1a depicts a block diagram of an embodiment 101 of the proposed arrangement. As described hereinbefore, the suggested division of functionalities between different entities is mainly functional (logical) and thus the physical implementation may include a number of further entities constructed by splitting any disclosed one into multiple ones and/or a number of integrated entities constructed by combining at least two entities together. The disclosed embodiment is intended for use with offline testing/execution, but the fulcrum of the present invention is generally applicable for online use as well.

Data interface/tester 102 may refer to at least one data interface entity and/or testing entity (test executor) providing the necessary external input data such as model, test case and log data to the other entities for storage, processing, and/or analysis, and output data such as analysis reports back to external entities. In some embodiments, at least part of the functionality of the entity 102 may be integrated with one or more other entities 104, 106, 108, 110, 112, 114, and 116. The entity 102 may provide data as is or convert or process it from a predetermined format to another upon provision.

Model handler, or in some embodiments validly called “parser”, 104 manages model data modeling at least the necessary part of the characteristics of the SUT in the light of the analysis procedure. The model may have been created using a suitable software tool such as Conformiq Qtronic™. The model of the SUT, which may be an XMI state machine model as mentioned hereinearlier, may be read and parsed according to predetermined settings into the memory of the arrangement and subsequently used in the analysis.

Test plan handler 106 manages test plan data relating to a number of test cases executed by the SUT for testing purposes. Again, Qtronic may be applied for generating the test plan and related files. Test plan data describing a number of test cases with e.g. the expected message sequences, message field contents and related expected outcomes may be read and parsed into the memory for future use during the analysis phase.

Test executor/SUT log handler 110 manages test execution log data that may be provided by a test executor (entity testing the SUT by running the generated tests against it) such as Nethawk EAST in the context of telecommunications network element or related testing. The log may thus depict test execution at the level of test scripts, for example. Additionally or alternatively, log(s) created by the actual SUT may be applied. The log(s) may be parsed and stored for future use during analysis.

The test execution log and the communications log, or the test execution logs of the test executor and the SUT, may contain some redundancy, i.e. information indicative of basically the same issue. This may be beneficial in some embodiments, wherein either the redundant information from both the sources is applied (compared, for example, and a common outcome established based on the comparison and e.g. predetermined deduction rules) or the most reliable source of any particular information can be selected as a trusted source on the basis of prior knowledge, for instance, and the corresponding information by the other entity be discarded in the analysis.

As one tangible example, the test executor may be implemented as modular software such as the aforesaid EAST, whereupon e.g. test script execution and logging is handled by module(s) different from the one handling the actual communications with the SUT. The communications may be handled by separate server/client components, for instance. Therefore, it may happen that the log based on test script execution indicates proper transmittal of a message, but the transmittal was not actually finished due to some issue in the communications-handling component. Instead, the separate communications log may more reliably indicate true accomplished message transfer between the text executor and the SUT, whereupon the communications log may be the one to be solely or primarily relied upon during the tracking of the messaging actions.

Communications log handler 112 manages communications log data such PCAP data. Communications logs describing message transfer between a plurality of entities, such as the test executor and the SUT, may be generated by tools such as Wireshark™ in the context of telecommunications network element or related testing. The message monitoring and logging may be configured to take place at one or more desired traffic levels such as the GSM protocol level. The related logs, or “capture files”, may be parsed and stored for use in the analysis.

The analyzer 114 may be utilized to analyze the communications and test execution logs against model, test plan data and the rule set 116 that defines the exploited analysis rules and is thus an important part of the analyzer configuration. It 114 may compare the test executing component and SUT input/output to the model of the system indicating the expected behavior according to the rule set. The rules may be modeled as XML. Potential use scenarios include, but are not limited to, ensuring that the correspondences between message fields matches the model, comparison of logged messages with test plan data, and identification of recurring failures, for instance.

The analyzer 114 may be configured to search at least one failure selected from the group consisting of: an existing log message unsupported by the model (may indicate a deficiency in the model to be corrected), a warning message in a text execution log, difference between sequence data of the model and the communications log, and difference between the message sequence of the test plan data and the communications log.

In the analyzer design, a certain rule, or “requirement”, may include a number of conditions and actions executed upon fulfillment of the conditions. A condition may evaluate into TRUE or FALSE (Boolean). One example of a condition is “value of field x in message y is equal to expected value in the model” and one other “erroneous status request reply from parser x has been received”. An action to be executed when the necessary conditions are met may imply writing out an analysis report about a certain event or executing another rule. Indeed, if the conditions of the rule evaluate properly according to a logical sentence formed by the applied condition structure, all the actions in the rule may be executed, preferably in that order they are found in the related rule definition entity such as an XML file. Multiple conditions and optionally condition blocks of a number of conditions may be combined in the condition structure of the logical sentence using Boolean operators such as AND, OR, or NOT.

Each condition and action type may be introduced in its own class implementing a common interface. Each type may have its own set of parameters which can be defined in the rule definition. Each condition class has advantageously access to model data and log data of a test run.

A portion of an applicable XML syntax for defining the rules is given in Table 1 for facilitating the implementation thereof. The disclosed solution is merely exemplary, however, as being understood by a skilled person.

TABLE 1
Portion of Exemplary XML Syntax for Rule Definition

| | | | No. | |
|---|---|---|---|---|
| | | | under | |
| Element | | Description | Parent | Data Values |
| <rca-requirements> | | The document's root element, | 1-1 | N/A (nested |
| | | under which all RCA require- | | elements) |
| | | ments are stored. | | |
| | <req> | The root element of a single re- | 0-N | N/A (nested |

| | quirement. | | elements) |
|---|---|---|---|
| <req-name> | The name of the requirement. | 1-1 | (String data) |
| | Must be unique. | | |
| <req-type> | Type of the requirement. “Timed” | 1-1 | “Timed” \| “Log |
| | type requirements are used in the | | Analysis” \| “SLT |
| | log/model retrieval process. “Log | | Analysis” |
| | Analysis” requirements are eval- | | |
| | uated first during the Analysis op- | | |
| | eration state. “Security Level Ta- | | |
| | ble Analysis” requirements are | | |
| | evaluated after all “Log Analysis” | | |
| | requirements have been received. | | |
| <req-timer> | Timer for timed requirements. | 0-1 | HH:MM:SS (e.g. |
| | | | “00:00:10” |
| | | | for 10 seconds) |
| <cond-list> | Root element for the list of condi- | 0-1 | N/A (nested |

| | tions to evaluate. NOTE: Condi- | | elements) |
|---|---|---|---|
| | tion list is not required for Timed | | |
| | type requirements. | | |
| <cond> | Root element for a single condi- | 1-N | N/A (nested |

| | tion. | | elements) |
|---|---|---|---|
| <cond-operator> | Logical operator for a single con- | 0-1 | “AND” \| “OR” \| |
| | dition, used from the 2^{nd} condition | | “NOT” |
| | in a list/block onwards. | | |
| <cond-type> | Type of the condition. Used by | 1-1 | (String data) |
| | the ReqXmlParser class to insert | | |
| | a reference to the class contain- | | |
| | ing the actual code for evaluating | | |
| | the condition of a specific type. | | |
| <cond-param | Data parameter for a condition. | 0-N | (Varies) |

| id=”x”> | | Multiple parameters may be used | | |
|---|---|---|---|---|
| | | for a condition, and their amount | | |
| | | and names depend on the condi- | | |
| | | tion type. Identified by the string | | |
| | | data in the XML parameter id. | | |
| | <cond-block> | Sub-statement under which more | 0-N | N/A (nested |

| | conditions can be placed in order | | elements) |
|---|---|---|---|
| | to create more complex condition | | |
| | structures. Cond elements are | | |
| | placed under blocks in the struc- | | |
| | ture. | | |
| <cond-block- | Operator for the entire block. | 1-1 | “AND” \| “OR” \| |

| operator> | | | | “NOT” |
|---|---|---|---|---|
| | <act-list> | Root element for the list of ac- | 1-1 | N/A (nested |

| | tions to execute. | | elements) |
|---|---|---|---|
| <act> | Root element for a single action. | 1-N | N/A (nested |

| | | | elements) |
|---|---|---|---|
| <act-type> | Type of the action Used by the | 1-1 | (String data) |
| | ReqXmlParser class to insert a | | |
| | reference to the class containing | | |
| | the actual code for executing the | | |
| | action of a specific type. | | |
| <act-param | Data parameter for an action. | 0-N | (Varies) |

| | |
|---|---|
| id=”x”> | Multiple parameters may be used |
| | for an action, and their amount |
| | and names depend on the action |
| | type. Identified by the string data |
| | in the XML parameter id. |

A portion of a simple example of a related XML file with a definition of a single rule incorporating two conditions and one action to be executed upon fulfillment of the conditions is presented below with comments (<!--comment-->).

| | |
|---|---|
| <!-- The document starts with a standard XML Header. | --> |

| | |
|---|---|
| <?xml version=“1.0”?> | |
| <!-- The root element of the documents is “rca-requirements”, and all requirements | |
| are placed under it in the XML tree structure. | --> |
| <rca-requirements> | |
| <!-- A single requirement starts with opening the “req” element. | --> |
| <req> | |
| <!-- The unique requirement ID string is given in the “req-name” element. This | |
| is used by RCA to identify the requirement encountering a fault, and to save | |
| data--> | |
| <!-- regarding its occurrence to the local database's Security Level Table.--> | |

<req-name>RCA-Logical-Analyzer-Unsupported-Exception-Location-Update-Reject-
Offline </req-name>
<!-- The requirement type (Timed / Log Analysis / SLT Analysis) is depicted in
the “req-type” element. In this case, the requirement is evaluated right after

| | |
|---|---|
| receiving the log data from the current test run. | --> |
| <req-type>Log Analysis</req-type> | |
| <!-- The list of conditions is built under the “cond-list” element. | --> |
| <cond-list> | |
| <!-- A single condition is built under a “cond” element. | --> |
| <cond> | |
| <!-- The type of the condition is listed in the “cond-type” element. In this | |
| case the type of the condition is “Test Execution Mode”. A class representing | |
| this specific type of condition exists in RCA, evaluating the condition based | |
| on different parameters given. | --> |
| <cond-type>Test Execution Mode</cond-type> | |
| <!-- Condition parameters are depicted as “cond-param” elements, of which | |
| there can be any amount from 0 to N per condition type. Different parameters | |
| are identified by the “id” XML attribute. In this case, a single parameter | |
| with the ID string “mode” is given, with “Offline” as its data. This condition | |
| evaluates true if the RCA is currently operating in the offline test execution | |
| mode. --> | |
| <cond-param id=“mode”>Offline</cond-param> | |
| <!-- The single condition ends by closing the “cond” element. | --> |
| </cond> | |
| <!-- Another condition in the structure is started by opening another “cond” | |
| element. --> | |
| <cond> | |
| <!-- From the 2nd condition onwards, the “cond-operator” is used to specify | |
| the logical sentence which is used to evaluate the requirement's conditions. | |
| In this case, the operator is “AND” denoting that both this and the previous | |
| condition need to evaluate to true for the requirement's action(s) to be | |
| triggered. --> | |
| <cond-operator>AND</cond-operator> | |
| <!-- In this case, the type of the condition is “Unsupported Message Check”, | |
| with its own evaluation code in RCA. | --> |
| <cond-type>Unsupported Message Check</cond-type> | |
| <!-- Three different parameters are given to the condition: “log” defining the | |
| execution log to evaluate against, “state machine” depicting the state machine | |
| in the model to search from, and “log msg id” depicting the name of the message | |
| in log to compare the model against. If the message is found to be not | |
| supported by the model, the condition evaluates to true. | --> |
| <cond-param id=“log”>Wireshark Log</cond-param> | |
| <cond-param id=“state machine”>LocationUpdate</cond-param> | |
| <cond-param id=“log msg id”>Location Updating Reject</cond-param> | |
| <!-- The single condition ends by closing the “cond” element. | --> |
| </cond> | |
| <!-- The condition list is ended by closing the “cond-list” element. | --> |
| </cond-list> | |
| <!-- The list of actions to be executed if the conditions are met is started | |
| by opening the “act-list” element. --> | |
| <act-list> | |
| <!-- A single action is started by opening the “act” element. | --> |
| <act> | |
| <!-- The action type is defined in an “act-type” element. In this case, the | |
| type is “Send Report”, triggering an analysis report to be added for the found | |
| fault. RCA contains specific code for executing this type of action with given | |
| parameters, in a similar manner to handling conditions. | --> |
| <act-type>Send Report</act-type> | |
| <!-- Parameters for actions are given in a manner similar to conditions, under | |
| “act-param” elements. In this case, there are two parameters. In “description | |
| ”, a human readable explanation for the discovered fault is given. In | |
| “blame”, a potential source of the fault is suggested. | --> |
| <act-param id=“description”>unsupported exception from SUT encountered | |
| in wireshark log: Location Update Reject</act-param> | |
| <act-param id=“blame”>model</act-param> | |
| <!-- The single action is ended by closing the “act” element. | --> |
| </act> | |
| <!-- The list of actions is ended by closing the “act-list” element. | --> |
| </act-list> | |
| <!-- The single requirement is ended by closing the “req” element. | --> |
| </req> | |
| <!-- An arbitrary amount of requirements can be added to the document in a | |
| similar fashion to the one in this example. At the end of the requirement document, | |
| the root element “rca-requirements” is closed. | --> |
| </rca-requirements> | |

The reporter 108 is configured to report on the outcome of the analysis. The whole report may be produced after the analysis or in parts during the analysis. For instance, updating the report may occur upon detection of each new failure by adding an indication of the failure and its potential (root) cause thereto.

The analysis report, such as a report file in a desired form such as XML form that may be later contemplated using e.g. a related XSL style sheet, may detail at least the discovered faults, the test cases they were discovered in and information on related messages between the test executor and the SUT. The report may contain a number of hyperlinks to the related test plan file(s) and/or other entities for additional information. The occurrences of the failures may be sorted either by test case or the corresponding analysis rule, for instance.

FIG. 1b illustrates a part of one merely exemplary analysis report 117 indicating the details 119 of detected few failures relating to the existence of messages in the communications log not considered as necessary in the light of the test plan, however. A header portion 118 discloses various details relating to the test and analysis environment such as version numbers and general information about the analysis results such as the number of failures found.

FIG. 1 c illustrates a potential use scenario of the proposed arrangement. Qtronic test model 120 and related HTML format test plan 122 may be first utilized to conduct the actual tests. Nevertheless, these and the logs resulting from the testing including e.g. Nethawk EAST test execution log 124 and Wireshark communications log 126 are utilized to conduct the analysis 128 and produce the associated report 130. The UI of the analyzer may be substantially textual such as a command line-based UI (illustrated in the figure) or a graphical one.

FIG. 2 illustrates the potential internals 202 of an embodiment of the arrangement 101 in accordance with the present invention from a more physical standpoint. The entity in question formed by e.g. one or more electronic devices establishing or hosting the arrangement 101, is typically provided with one or more processing devices capable of processing instructions and other data, such as one or more microprocessors, micro-controllers, DSPs (digital signal processor), programmable logic chips, etc. The processing entity 220 may thus, as a functional entity, physically comprise a plurality of mutually co-operating processors and/or a number of sub-processors connected to a central processing unit, for instance. The processing entity 220 may be configured to execute the code stored in a memory 226, which may refer to the analysis software and optionally other software such as testing and/or parsing software in accordance with the present invention. The software may utilize a dedicated or a shared processor for executing the tasks thereof. Similarly, the memory entity 226 may be divided between one or more physical memory chips or other memory elements. The memory 226 may further refer to and include other storage media such as a preferably detachable memory card, a floppy disc, a CD-ROM, or a fixed storage medium such as a hard drive. The memory 226 may be non-volatile, e.g. ROM (Read Only Memory), and/or volatile, e.g. RAM (Random Access Memory), by nature. The analyzer code may be implemented through utilization of an object-oriented programming language such as C++ or Java. Basically each entity of the arrangement may be realized as a combination of software (code and other data) and hardware such as a processor (executing code and processing data), memory (acting as a code and other data repository) and necessary I/O means (providing source data and control input for analysis and output data for the investigation of the analysis results). The code may be provided on a carrier medium such as a memory card or an optical disc, or be provided over a communications network.

The UI (user interface) 222 may comprise a display, e.g. an (O)LED (Organic LED) display, and/or a connector to an external display or a data projector, and a keyboard/keypad or other applicable control input means (e.g. touch screen or voice control input, or separate keys/buttons/knobs/switches) configured to provide the user of the entity with practicable data visualization and/or arrangement control means. The UI 222 may include one or more loudspeakers and associated circuitry such as D/A (digital-to-analogue) converter(s) for sound output, e.g. alert sound output, and a microphone with A/D converter for sound input. In addition, the entity comprises an interface 224 such as at least one transceiver incorporating e.g. a radio part including a wireless transceiver, such as WLAN (Wireless Local Area Network), Bluetooth or GSM/UMTS transceiver, for general communications with external devices and/or a network infrastructure, and/or other wireless or wired data connectivity means such as one or more wired interfaces (e.g. LAN such as Ethernet, Firewire, or USB (Universal Serial Bus)) for communication with network(s) such as the Internet and associated device(s), and/or other devices such as terminal devices, control devices, or peripheral devices. It is clear to a skilled person that the disclosed entity may comprise few or numerous additional functional and/or structural elements for providing beneficial communication, processing or other features, whereupon this disclosure is not to be construed as limiting the presence of the additional elements in any manner.

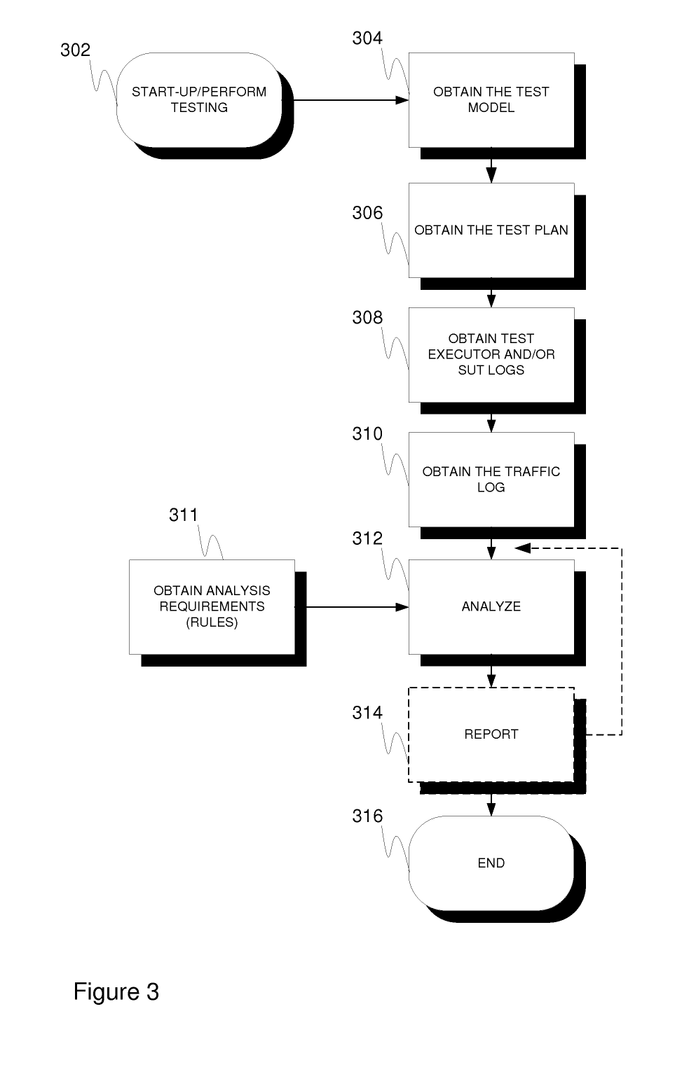

FIG. 3 discloses, by way of example only, a method flow diagram in accordance with an embodiment of the present invention. At 302, the arrangement for executing the method is obtained and configured, for example, via installation and execution of related software and hardware. A model of the SUT, a test plan, and an analyzer rule set may be generated. The test cases may be executed and the related logs stored for future use in connection with the subsequent analysis steps.

At 304, the generated model data such UML-based model data is acquired by the arrangement and procedures such as parsing thereof into the memory of the arrangement as an object structure may be executed.

At 306, the test plan data is correspondingly acquired and parsed into the memory.

At 308, test execution log(s) such as the test executor log and/or the SUT log is retrieved and parsed.

At 310, a communications log is retrieved and parsed. This may be done simultaneously with the preceding phase provided that the tasks are performed in separate parallel threads (in a thread-supporting implementation).

At 312, the analysis of the log data against the model and test plan data is performed according to the analysis rules provided preferably up-front to the analyzer at 311.

At 314, the reporting may be actualized, when necessary (optional nature of the block visualized by the broken line). The broken loopback arrow highlights the fact the reporting may take place in connection with the analysis in a stepwise fashion as contemplated hereinbefore.

At 316, the method execution including the analysis and reporting is ended.

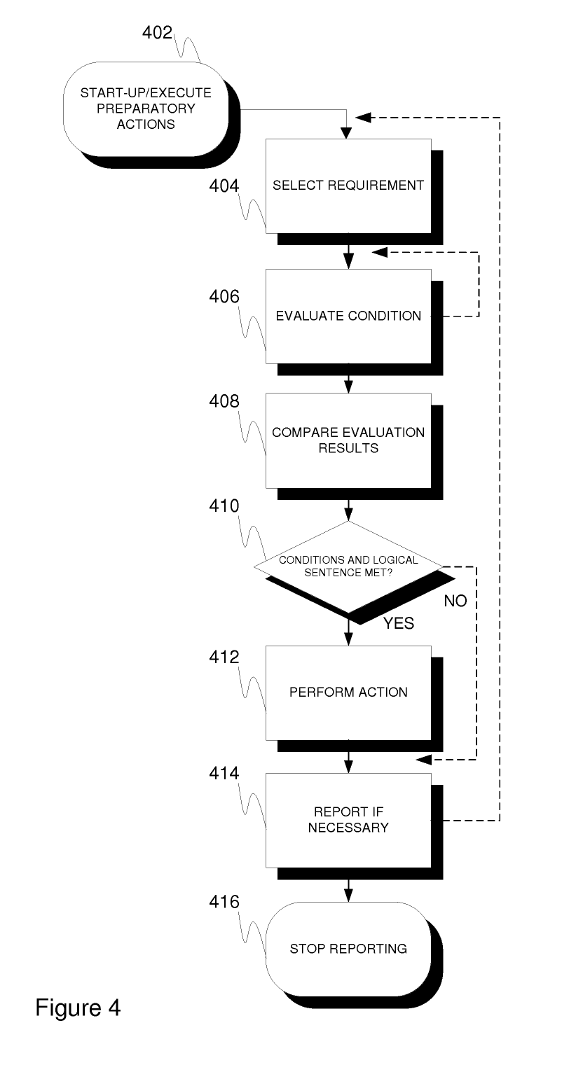

FIG. 4 discloses, by way of example only, a method flow diagram in accordance with an embodiment of the present invention with further emphasis on the analysis item 312 of FIG. 3.

At 402, a number of preparatory actions such as parsing the analysis rule data into the memory of the analyzer may be performed (matches with item 311 of FIG. 3). Such data may contain rules (“requirements”) for decision-making along with the corresponding evaluation and execution code.

At 404, a requirement is picked up from the parsed data for evaluation against the test run data.

At 406, the conditions of the requirement are evaluated returning either true (condition met) or false (condition not met). For the evaluation of each condition, an evaluator class corresponding to the condition type may be called depending on the embodiment. A broken loopback arrow is presented to highlight the possibility to evaluate multiple conditions included in a single requirement. A single condition may relate to a parameter value, state information, a message field value, etc.

Optionally, a number of conditions may have been placed in a condition block of a requirement potentially including multiple condition blocks. Each condition block may correspond to a sub-expression (e.g. (A AND B)) of the overall logical sentence. Condition blocks may be utilized to implement more complex condition structures with e.g. nested elements.

At 408, the evaluation results of the conditions and optional condition blocks are compared with a full logical sentence associated with the requirement including the condition evaluations and condition operators between those (e.g. (A AND B) OR C), wherein A, B, and C represent different conditions).

Provided that the logical sentence that may be seen as an “aggregate condition” is fulfilled, which is checked at process item 410, the action(s) included in the requirement are performed at 412. An action may be a reporting action or an action instructing to execute another rule, for instance.

A corresponding report entry (e.g. fulfillment of the logical sentence, which may indicate a certain failure, for example, or a corresponding non-fulfillment) may be made at 414. The execution may then revert back to item 404 wherein a new requirement is selected for analysis.

The analysis execution is ended at 416 after finishing the analysis and reporting tasks. At least one report file or other report entity may be provided as output.

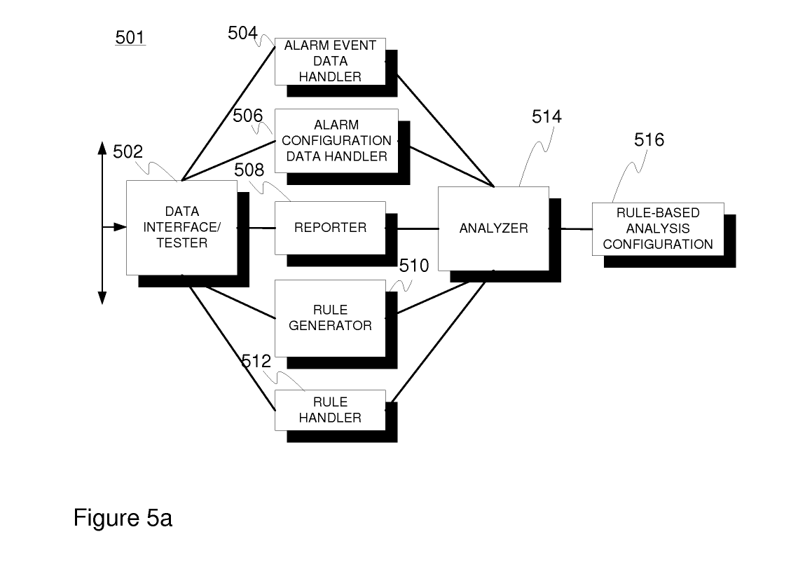

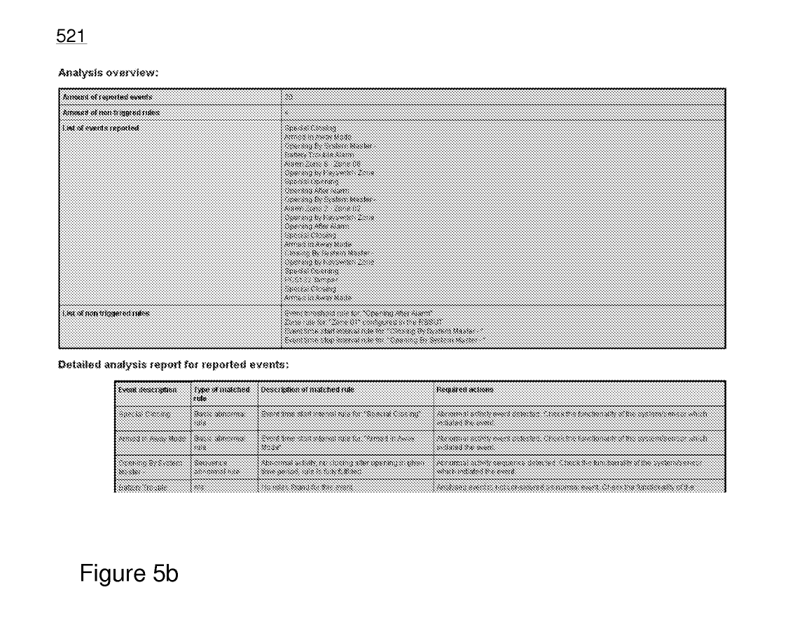

FIG. 5a depicts, at 501, a block diagram of an embodiment of the proposed RTA arrangement. As described hereinbefore, the suggested division of functionalities between different entities is mainly functional (logical) and thus the physical implementation may include a number of further entities constructed by splitting any disclosed one into multiple ones and/or a number of integrated entities constructed by combining at least two entities together.

Data interface/tester 502 refers to at least one data interface entity providing the necessary external input data such as alarm configuration and alarm event data to the other entities for processing and analysis, and output data such as analysis reports back to external entities. The entity may provide data as is or convert or process it from a predetermined format to another upon provision.

Alarm event data handler entity 504 parses and obtains XML event data received from the RSSUT. This file is parsed for automatic rule model creation procedure. The XML file may be read and parsed according to predetermined settings into the memory of the arrangement and subsequently used in analysis.

Alarm configuration data handler entity 506 parses and obtains XML event data The alarm configuration data is also parsed for the model creation procedure. This file contains definitions for the available alarm zones and it is also received from the RSSUT. This information can be used for determining all alarm zones that are available. If an alarm is issued from an alarm zone that is not specified beforehand, it is considered as an abnormal activity.

The analyzer may be utilized to analyze the RSSUT event data against a rule set that defines the exploited analysis rules and is thus an important part of the analyzer configuration. The rules used in analysis may be modeled as XML. Potential use scenarios include, but are not limited to: the RTA to detect e.g. if a RSSUT sensor is about to malfunction and sends alarms with increasing time intervals, if a sensor has never sent an alarm, and if the RSSUT sends an unusual event, or sends an event at unusual time.

Rule generator 510 and Rule handler 512 take care of rules applied. There are two types of rules that can be specified for the RTA, which are basic rule and sequence rule. Basic rule describes aspects that describe non-sequential activities. These include for example counters for certain events, listing all allowed events that can be generated by the surveillance system, and listing all available alarm zones. Sequence rule describes a group of events forming a specific sequence that can occur in the surveillance system. For example the sequence rule can be used describing an activity where user sets surveillance system on and after certain time period sets the system off.

The both rule types, basic and sequence, are either normal or abnormal. Normal rule describes an activity which is considered as allowed and normal behaviour of the surveillance system. Normal rules can be created either automatically or manually. Abnormal rule describes an activity which is not considered as a normal behaviour of the surveillance system. E.g. when certain sensor initiates alerts with increasing frequency it can be considered as malfunctioning sensor. Abnormal rules can only be created manually.

Basic rule describing normal activity:

```
<basic-rule>
    <rule-description>Available alarm zone: zone 01</rule-description>
    <rule-type>normal</rule-type>
    <zone>zone 01</zone>
</basic-rule>
```

Basic rule describing abnormal activity:

```
<basic-rule>
<rule-description>Alarm counter rule for indicating abnormal amount of
alarms</rule-description>
      <rule-type>abnormal</rule-type>
      <event-counter>2</event-counter>
      <time-threshold>
                  <type>week</type>
                  <value>1</value>
            </time-threshold>
            <event>Alarm zone 6  - zone  06</event>
</basic-rule>
```

Sequence rule describing normal activity:

```
<sequence-rule>
      <rule-description>Normal opening after alarm</rule-description>
      <rule-type>normal</rule-type>
      <time-threshold>
            <type>minute</type>
            <value>1</value>
      </time-threshold>
      <event>Alarm zone 6  - zone  06</event>
      <event>Opening After Alarm</event>
</sequence-rule>
```

Sequence rule describing abnormal activity:

```
<sequence-rule>
      <rule-description>Abnormal sequence of alarms</rule-description>
      <rule-type>abnormal</rule-type>
      <time-threshold>
            <type>minute</type>
            <value>1</value>
      </time-threshold>
      <event>Alarm zone 3 - zone 03</event>
      <event>Alarm zone 6 - zone 06</event>
      <event>Alarm Zone 4 - Zone 04</event>
</sequence-rule>
```

The reporter 508 is configured to report on the outcome of the analysis. The whole report is produced after the analysis 514, 516. The analysis report, such as a report file in a desired form such as XML form that may be later contemplated using e.g. a related XSL style sheet, may detail at least the discovered abnormal activities and information on related events between the RTA and the RSSUT.

The functionality of the RTA may be divided into two main phases: 1) in start-up phase the RTA initializes all required components and creates rules according to the RSSUT data to support the analysis phase, and 2) in analysis phase the RTA analyzes the RSSUT testing data and reports if abnormalities are found.

FIG. 5b illustrates a part of an analysis report 521 produced by the RTA.

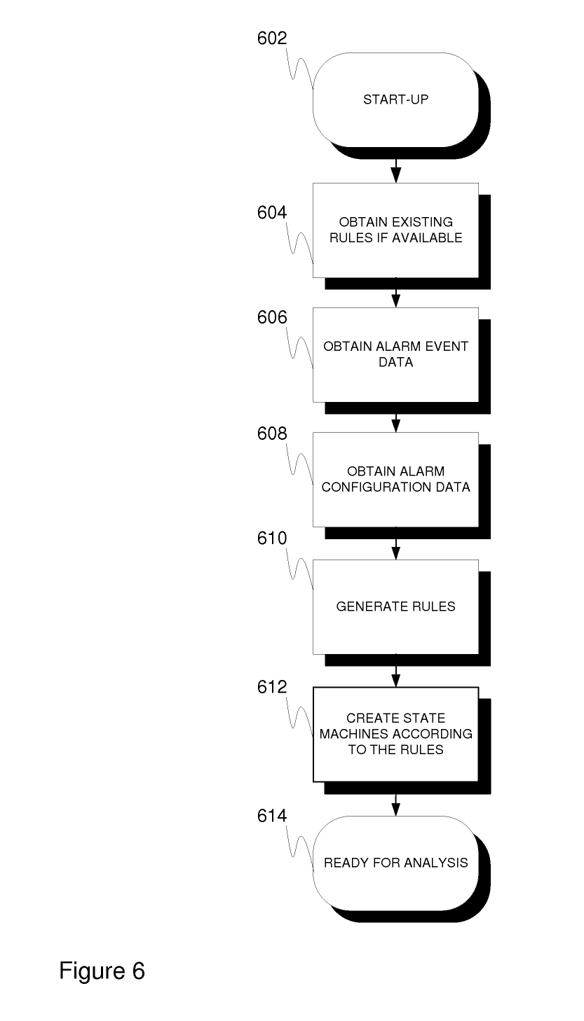

FIG. 6 discloses a method flow diagram in accordance with an (RTA) embodiment of the present invention. At 602, the arrangement for executing the method is configured and initialization and rule generation is started. At 604, the first step in the initialization phase is to check if a file containing rules is already available for the RTA. If the file exists, then the file will be loaded and parsed. Then at 606, the RTA obtains and parses the alarm event data received from the RSSSUT. This file is parsed for automatic rule model creation procedure. At 608, alarm configuration data file is also parsed for the model creation procedure. After obtaining the required files at 610, the RTA automatically recognizes patterns in the RSSUT behaviour, and generates rules to recognize normal and abnormal activities in the RSSUT during the analysis phase. This is performed by first analyzing an example alarm event data file and creating the rules for the rule based analysis by statistical and pattern recognition methods. These rules describe normal, and suspected abnormal behaviour of the RSSUT.

A rule is either a single event or can comprise of sequences of events. These rules are stored into an XML file and this file can be utilized directly in future executions of the RTA. When the rules are generated automatically, the RTA utilizes sample based analysis, which means that the RTA utilizes the real events collected from the RSSUT and creates rules for normal and abnormal activity according to those events. At 612, RTA creates data structures from the XML formatted rules. These data structures reside in the PC memory, and are used during the analysis phase. At 614, the method execution including the startup functionalities is ended.

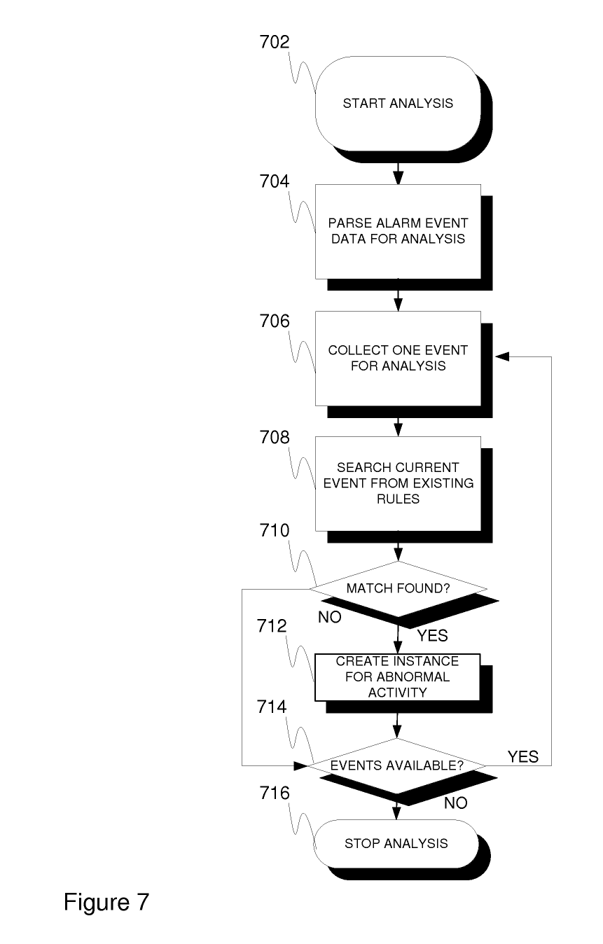

FIG. 7 discloses a method flow diagram in accordance with the RTA embodiment of the present invention given further emphasis on the analysis phase, which starts at 702 preferably seamlessly after the initialization phase described in FIG. 6. The rules generated in the initialization phase accompanied by the analysis phase enables the RTA to detect e.g. if a RSSUT sensor is about to malfunction and sends alarms with increasing time intervals, if a sensor has never sent an alarm, and if the RSSUT sends an unusual event, or sends an event at unusual time.

The analysis phase contains following procedures: in the first step at 704 alarm event data file is used. This XML file is another RSSUT event log and it contains events occurred in the surveillance system. The RTA parses and collects events from this file. When the parsing procedure is finished, the second step is initiated at 706, where RTA collects one event for analysis. This analysis phase will be performed for each unique parsed event. The search procedure at 708 utilizes the data structures created during the initialization phase. In this procedure the RTA will search correspondences for the current event from the data structures. If abnormality is found at 710, the RTA creates a report entry instance at 712 indicating that the alarm event data file contains some abnormal activities, which will further indicate that the surveillance system has abnormal activity. When the current event is handled, the RTA checks if there is unhandled events available (at 714). If there still are events to be analyzed, the RTA starts the analysis again from the second step at 706. A loopback arrow is presented to highlight the possibility to evaluate multiple events. If there are no new events for analysis, the RTA will stop the analysis. The analysis execution is ended at 716 after finishing the analysis and reporting tasks. At least one report file or other report entity may be provided as output.

The mutual ordering and overall presence of the method items of the method diagrams discussed above may be altered by a skilled person based on the requirements set by each particular use scenario.

Consequently, a skilled person may, on the basis of this disclosure and general knowledge, apply the provided teachings in order to implement the scope of the present invention as defined by the appended claims in each particular use case with necessary modifications, deletions, and additions, if any. For example, at least some analysis rules and related evaluation code may be generated in an automated fashion from the system model (instead of manual work) utilizing predetermined rule-derivation criteria. The analysis reports may be subjected to machine-based exploitation; the results may be tied to a “dashboard”, or “control panel”,-type application with interaction-enabling UI.

1-19. (canceled)

20. An electronic arrangement (101, 202) comprising one or more electronic devices for analyzing a model-based testing scenario relating to a system under test (SUT), said arrangement comprising
a model handler entity (104) configured to obtain and manage model data indicative of a model (120) intended to at least partially exhibit the behavior of the SUT,
a test plan handler entity (106) configured to obtain and manage test plan data indicative of a number of test cases (122) relating to the model and the expected outcome thereof,
a test execution log handler entity (110) configured to obtain and manage test execution log data (124) indicative of the execution of the test cases by a test executor entity and/or the SUT,
a communications log handler entity (112) configured to obtain and manage communications log data (126) indicative of message traffic between the test executor entity and the SUT, and
an analyzer entity (114, 128) configured to detect a number of failures and their causes in the model-based testing scenario on the basis of the model data, test plan data, test execution log data and communications log data, wherein the analyzer is configured to apply a rule-based logic (116) to determine the failures to be detected.

21. The arrangement of claim 20, wherein the analyzer entity is configured to compare test plan data, test execution log data, and/or communications log data with model data to detect errors in the model.

22. The arrangement of claim 20, wherein the analyzer entity is configured to compare model data, test execution log data, and/or communications log data with test plan data to detect errors in the test plan data, such as errors in one or more test cases.

23. The arrangement of claim 20, wherein the analyzer entity is configured to compare model data and/or test plan data with test execution log data and/or communications log data to detect errors in the related test runs.

24. The arrangement of claim 20, wherein the model of the SUT includes a state machine model, preferably a UML (Unified Modeling Language)-based state machine model.

25. The arrangement of claim 20, wherein the model of the SUT is at least partially in XMI (XML Metadata Interchange) format.

26. The arrangement of claim 20, wherein the test plan is at least partially in HTML (Hypertext Markup Language) format.

27. The arrangement of claim 20, wherein the communications log is or at least includes data in PCAP (packet capture) format.

28. The arrangement of claim 20, wherein the rule-based logic applies Boolean logic and operators.

29. The arrangement of claim 20, wherein the rules of the rule-based logic are modeled via XML (eXtensible Markup Language).

30. The arrangement of claim 20, comprising a report generation entity (108) configured to create a report (117) including details (119) relating to the detected failures and their causes, said report optionally being in XML-based (eXtensible Markup Language) format to be visualized utilizing an applicable XSL-based style sheet (Extensible Stylesheet Language).

31. The arrangement of claim 20, wherein a rule of the rule-based logic comprises a number of conditions and a number of actions that are to be performed upon fulfillment of a logical sentence applying the conditions, wherein the fulfillment optionally indicates the detection of a failure.

32. The arrangement of claim 20, wherein the SUT is or at least includes a communications network element, optionally an MSS (Mobile Switching Centre Server).

33. A method for analyzing a model-based testing scenario relating to a system under test (SUT) to be performed by an electronic device or a system of multiple devices, comprising
obtaining model data indicative of a model intended to at least partially exhibit the behavior of the SUT (304),
obtaining test plan data indicative of a number of test cases relating to the model and the expected outcome thereof (306),
obtaining test execution log data indicative of the execution of the test cases by the test executor entity and/or the SUT (308),
obtaining communications log data indicative of message traffic between the test executor entity and the SUT (310), and
conducting analysis incorporating detecting a number of failures and their causes in the model-based testing scenario on the basis of the model data, test plan data, test execution log data and communications log data, wherein a rule-based logic is applied (311) to determine a number of characteristics of the failures to be detected (312).

34. The method of claim 33, further comprising generating an analysis report disclosing details relative to the detected failures and their causes (314).

35. The method of claim 33, wherein a rule of the rule-based logic comprises a number of conditions and a number of actions to be taken by the analyzer provided that a logical sentence incorporating the conditions is satisfied (404, 406, 408, 410, 412), and wherein the fulfillment of the logical sentence implies a detection of a failure that is preferably subsequently indicated in a generated analysis report (314, 414).

36. The method of claim 33, wherein a rule of the rule-based logic comprises a number of conditions and a number of actions to be taken by the analyzer provided that a logical sentence incorporating the conditions is satisfied (404, 406, 408, 410, 412), and wherein the fulfillment of the logical sentence implies a detection of a failure that is preferably subsequently indicated in a generated analysis report (314, 414) and the logical sentence connects different conditions and optionally blocks of multiple conditions with Boolean operators.

37. A computer program product, comprising a computer usable medium provided with code means adapted, when run on a computer, to control the computer to analyze a model-based testing scenario relating to a system under test (SUT), comprising
obtaining model data indicative of a model intended to at least partially exhibit the behavior of the SUT (304),
obtaining test plan data indicative of a number of test cases relating to the model and the expected outcome thereof (306),
obtaining test execution log data indicative of the execution of the test cases by the test executor entity and/or the SUT (308),
obtaining communications log data indicative of message traffic between the test executor entity and the SUT (310), and
conducting analysis incorporating detecting a number of failures and their causes in the model-based testing scenario on the basis of the model data, test plan data, test execution log data and communications log data, wherein a rule-based logic is applied (311) to determine a number of characteristics of the failures to be detected (312).
